(19) United States
(12) Patent Application Publication
(10) Pub. No.: US 2011/0189552 A1
(43) Pub. Date: Aug. 4, 2011

(54) DRAINING MEANS FOR A FUEL CELL SYSTEM AND RELATED ADJUSTMENT MODE

(75) Inventors: Sadok Garnit, Paris (FR); Francis Roy, Les Ulis (FR); Guillaume Joncquet, Paris (FR); Jean-Philippe Poirot-Crouvezier, Saint Georges De Commiers (FR)

(73) Assignees: Commissariat A L'Energie Atomique Et Aux Energies Alternatives, Paris (FR); Peugeot Citroen Automobiles S.A., Velizy Villacoublay (FR)

(21) Appl. No.: 13/055,223

(22) PCT Filed: Jul. 22, 2009
(86) PCT No.: PCT/EP2009/059393

§ 371 Date: Apr. 20, 2011

(30) Foreign Application Priority Data
Jul. 25, 2008 (KR) 0855140

(51) Int. Cl. H01M 8/06

(52) U.S. Cl. 429/410

(57) ABSTRACT

The invention relates to a draining device for a fuel cell (FC). The effluents from a hydrogen FC comprising a recirculation circuit have to be regularly drained in order to guarantee optimum operation. The draining devices of the prior art are characterized by significant variations in the hydrogen concentration of the effluents. The invention consists in incorporating the draining means in the device for separating the liquid and gas phases of the effluents. Advantageously, means for fine regulation of the draining flow rate are provided, which makes it possible to limit the losses of hydrogen the drained effluents.

This application is a national phase application under §371 of PCT/EP2009/059393, filed Jul. 22, 2009, which claims priority to French Patent Application No. 0855140, filed Jul. 25, 2008, the entire content of which is expressly incorporated herein by reference.

This invention applies to the field of the fuel cell (FC) and more particularly to the applications operating at low temperature and using a membrane as electrolyte.

### BACKGROUND OF THE INVENTION

The cells concerned are those supplied with pure or virtually pure hydrogen. Even in the “recirculation” operating modes, where the hydrogen is reinjected into the cell, it is necessary to regularly drain the system in order to remove the pollutants and to prevent the increase in the concentration of nitrogen from damaging the performance of the system. Several draining modes have been devised, the two main ones being the periodic opening of a drain valve, a mode described as “dead end” or frontal by a person skilled in the art, and the creation of an orifice calibrated according to the desired draining flow rate. The present invention relates to this second mode, which theoretically exhibits mainly the advantage, with respect to the first mode, of avoiding the sudden variations in hydrogen flow rate inherent in the first mode. However, the calibrated orifice draining devices of the prior art exhibit the disadvantage that the effluents which contain water in the liquid phase, which constitutes the majority of the operating cases, create unevennesses in the draining flow rate which, in the end, recreate the disadvantages of the first mode. The following patent applications (US 2002/006534, US 2005/233191 and US 2006/086074) have a tendency to solve this problem by providing an adjustable draining function coupled with a phase separation function. However, these patents and patent applications do not make it possible to adjust the draining flow rate over the whole of the operating range of a fuel cell. The document WO 2007/010372 has addressed this problem by providing two drain valves, the flow rates of which can be combined in order to broaden the operating range. However, this improvement does not provide sufficient flexibility to allow ready adaptation to the scenarios which can be envisaged for use of the fuel cell.

### SUMMARY OF THE INVENTION

The present invention solves this problem by providing draining means coupled with the phase separation function, said means being able to be parameterized in a simple way in order to treat the majority of the scenarios which can be envisaged for use of the fuel cell.

To this end, the invention discloses a circuit for recycling fuel or oxidant coupled to a fuel cell comprising means for draining the products of the reactions from the cells and means for separating the phases of said products, said draining means constituting an outlet of the means for separating the phases and comprising several calibrated outlet orifices each controlled by an electromechanical valve, the opening and the closing of which are controlled in order to choose the group of the outlet orifices which are active at a given instant, said recycling circuit being wherein said calibrated orifices are positioned in a housing, the face of which internal to the means for separating the phases has at least one hole with dimensions suited to the calibers of the outlet orifices and is capable of moving in order to hide a portion of the calibrated orifices under the control of means chosen from the group of the electrical and pneumatic means.

Advantageously, the housing has substantially the shape of a cylinder and the movement of the internal face of said cavity is a rotary movement.

Advantageously, the face internal to the separating means has a single hole, the position of which corresponds either to the activation of just one of the outlet orifices or to the complete passivation of the draining means.

Advantageously, the face internal to the means for separating the phases has a single hole, the position of which corresponds either to the activation of at least two of the related outlet orifices or to the complete passivation of the draining means.

Advantageously, a module is provided at the outlet of the draining means in order to carry out a treatment of the effluents chosen from the group consisting of dilution and catalytic incineration.

The invention also discloses a process for the production of an electric current in a fuel cell comprising an assembly of individual cells having an anode and a cathode, said assembly being supplied with fuel and with oxidant, one or other being composed of a circuit for recycling the gas mixture, said process comprising a stage of draining the products of the reactions from the cells, the flow rate for effluents of which, at the outlet of the draining stage, is controlled by alternate opening/closing of several calibrated orifices, said process being wherein said calibrated orifices are positioned in a housing, the face of which internal to the means for separating the phases has at least one hole with dimensions suited to the calibers of the outlet orifices and in that said process comprises a stage of moving said internal face of said housing by means chosen from the group of the electrical and pneumatic means in order to hide a portion of the calibrated orifices.

Advantageously, the mode of control of the flow rate for effluents at the outlet of the draining stage is combined with a variation in the pressure in the hydrogen feed line.

The invention additionally exhibits the advantage of providing greater compactness since two functions, carried out in the prior art in two physically separate devices, are integrated in just one assembly having the dimensions of the bulkier of them (the phase separator). In addition, several alternative embodiments allow broad operating power ranges, if appropriate by providing cylinders carrying one or more orifices optionally controlled by one or more valves, each cylinder being optimized for one of the operating ranges. Finally, it will emerge from the description that the concept and device are simple and inexpensive to produce, to maintain and to manage.

### BRIEF DESCRIPTION OF THE DRAWINGS

A better understanding of the invention will be obtained and its various characteristics and advantages will emerge from the description which follows of several embodiments and from its appended figures, in which:

FIG. 1 represents an architecture from the prior art of an FC with recirculation of hydrogen according to patent application US20060110640;

FIG. 2 represents the flowsheet of a phase separator incorporating a calibrated orifice for draining gas in one embodiment of the invention;

FIG. 3 represents a selector of one calibrated orifice for draining gas from three in one embodiment of the invention;

FIG. 4 represents a selector of zero, one or two calibrated orifices for draining gas from five in one embodiment of the invention;

FIG. 5 represents an example from the prior art of regulating the concentration of nitrogen in the hydrogen line by periodic draining;

FIG. 6 represents an example of regulating the concentration of nitrogen in the hydrogen line by alternate opening and closing of a draining line incorporating a calibrated orifice in one embodiment of the invention.

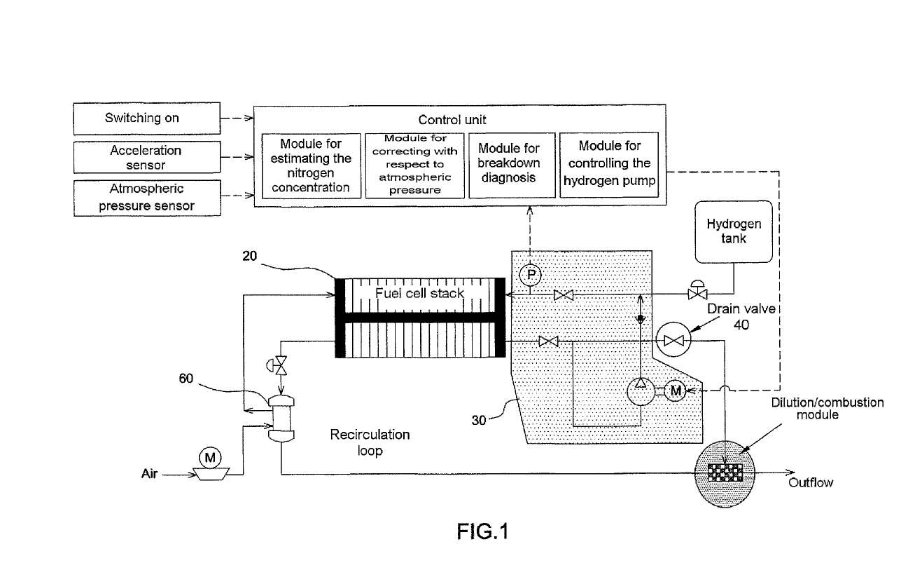

FIG. 1 represents the architecture of an FC 10 of the prior art with recirculation of hydrogen 30. An FC is a stack of individual cells 20 in which an electrochemical reaction takes place between two reactants which are introduced continuously. The fuel is brought into contact with the anode and the oxidant into contact with the cathode. The reaction is subdivided into two half reactions (an oxidation and a reduction) which take place, on the one hand, at the anode/electrolyte interface and, on the other hand, at the cathode/electrolyte interface. They can only take place if there exists a conductor of ions between the two electrodes (electrolyte) and a conductor of electrons (the external electrical circuit). The stack of cells is only the site of the reaction: the reactants have to be introduced therein and the products and unreactive entities have to be discharged therefrom, just like the heat produced. Finally, the electrical circuit has to be connected to the two terminals of the stack. In the systems using hydrogen and atmospheric air as reactants, the air is conveyed to the cell by a compressor and passes through a series of components (filter, heat exchanger, humidifier, etc.) before entering the cell at the cathode. At the cathode outlet, the air is generally laden with water in the liquid and vapor form. A portion of this water is recovered for the requirements of the humidification and then the residual gas is often discharged via a blow-off valve which makes possible the pressure maintenance of the line. On the anode side, the hydrogen can result from a large number of different sources which are generally also sources of pressure, making it possible to avoid resorting to a device for compressing the gas. It is therefore generally conveyed to the cell after having passed through one or more pressure-reducing valves or solenoid valves applying the pressure planned for in the line. At the cell outlet, several scenarios are possible: either the gas exiting from the anode is sufficiently pure and it can be in part reinjected at the cell inlet, so as to provide a sufficient supply of water to the cell, or it is simply drained at regular intervals in order to discharge the pollutants while minimizing the amount of hydrogen drained. In the first case, the term used is recirculation of the hydrogen and this is the commonest operating mode with regard to systems supplied with hydrogen and air. The transfer of nitrogen through the membrane between the cathode side and the anode side is the main reason why one of these two operating modes has to be applied to the anode. However, even the case of the recirculation, draining is necessary in order to prevent the concentration of the nitrogen from reaching values highly damaging to the performance of the cell. The commonest operation thus combines recirculation and draining. In FIG. 1, the drain valve 40 is installed on a branch line on the recirculation circuit 30. In this implementation of the prior art, a phase separator is not provided. However, this component is generally essential to the satisfactory operation of the FC system incorporating recirculation. This is because the passage of liquid water through the device impelling the recycled gas (pump or ejector) can detrimentally affect the operation of the cell or of the auxiliary device as a result of the great difference in density between the hydrogen (very light) and the liquid water. In point of fact, at the cell outlet on the anode side, liquid water is present in the majority of the cases of operation. Furthermore, if draining is carried out continuously via a calibrated orifice, the passage of a two-phase fluid can also present a problem by rendering the draining flow rate uneven. In addition, the water recovered at the outlet of the phase separator can be reinjected into the humidifier 60. This is because the humidifying of the electrolyte membranes of the cells of the FC is a function essential to the satisfactory operation thereof.

### DETAILED DESCRIPTION OF PREFERRED EMBODIMENT

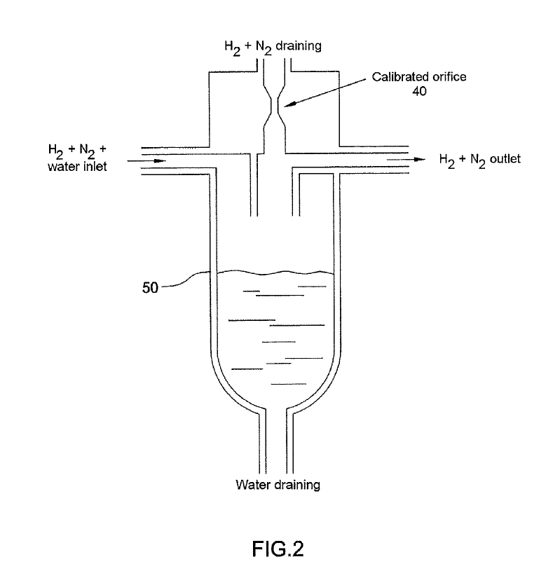

As indicated in FIG. 2, which represents the flowsheet of a phase separator incorporating a calibrated orifice for the draining of gas, in one embodiment of the invention, a phase separator 50 is provided on a branch line of the recirculation circuit. An additional outlet is inserted in the chamber of the phase separator and comprises a draining means 40. In this example, the draining means is an orifice, the caliber of which is chosen according to the draining flow rates to be provided. Advantageously, the orifice is situated in a region close to the outlet of the separator where the gas is freed from all the liquid present at the inlet.

By way of indication, the flow rate for draining the gases, for a cell with a nominal power of 20 kW, varies between 1 and 2 SI/min for gas draining operations and between 10 and 60 ml/min for water draining operations. In this implementation, the draining flow rate cannot be adjusted. However, it is possible to provide a valve for periodic opening/closing downstream of the calibrated orifice which will make possible fine regulating. By adjusting the times for opening and closing the valve, it is possible to reduce the hydrogen losses.

In the cases where finer adjusting of the draining flow rate would be necessary, typically ½ to ¾ SI/min of draining gas according to the operating point, several draining pipes with calibrated orifices having different cross sections can be installed on the separator. Each draining line thus created can be connected to a valve which will or will not render it active during the operation of the system. Alternatively, a device for selecting the orifice can be installed directly in the phase separator. If the orifices are positioned on the same line, use may be made of a perforated plate which is relocated so as to cause the hole or holes in the plate to coincide with one or more calibrated orifices. Nevertheless, the most advantageous configuration, in particular in terms of compactness, is that where the orifices are positioned in a circle. The selector is then a perforated disk which it is sufficient to rotate in order for the hole or holes present in it to coincide with one or more orifices.

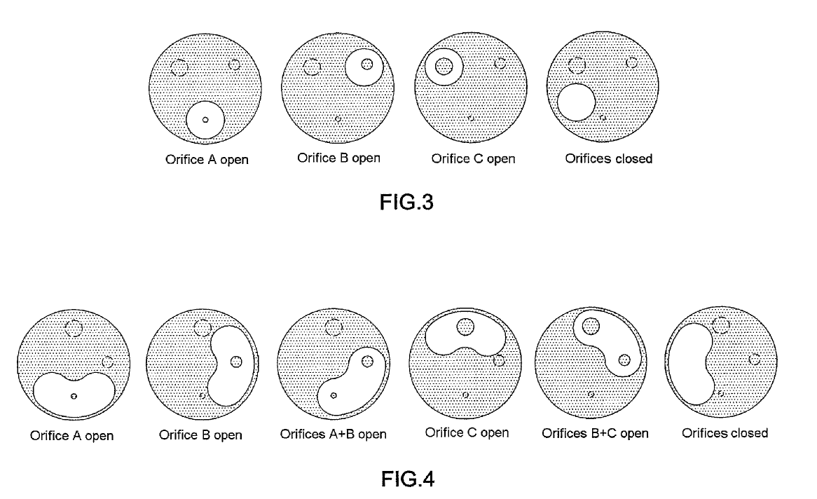

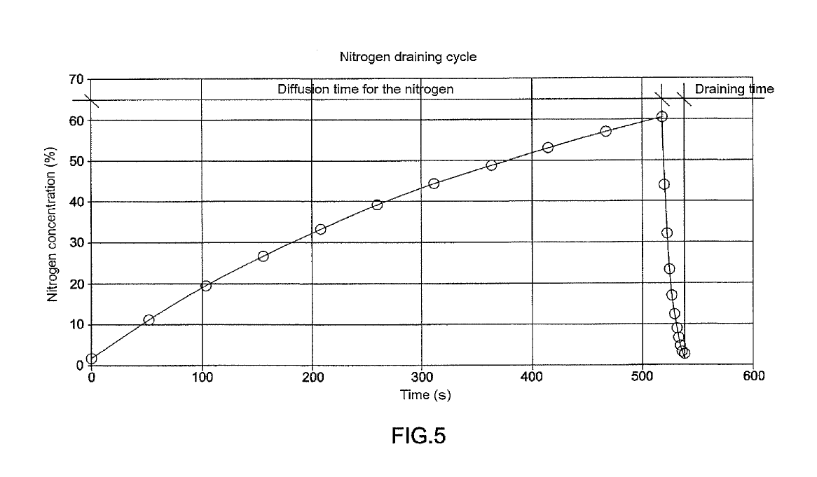

Two examples of selectors which make possible a better understanding of the operation of this device are presented in FIGS. 3 and 4. In FIG. 3, the disk situated on the internal face of the cylinder has just one hole, the diameter of which is greater than that of the biggest of the calibrated orifices of the separator. It can take three opening positions, each corresponding to one of the orifices, the draining being deactivated in all the other positions of the disk. In FIG. 4, the disk also comprises just one hole but with a specific configuration which makes it possible to provide for the opening of two related orifices simultaneously, which makes it possible to select five different flow rates. By way of indication, for a 20 kW cell, the holes calibrated can be 0.15, 0.2 and 0.25 mm in diameter. This distribution in diameter will make it possible to control the draining flow rate in all real-life situations. It should be noted that, during the startup, the hydrogen pressure is low and thus the selector will be positioned over the biggest hole. As the pressure increases, the selector will change in position in order to ensure a uniform draining flow rate. This proportioning depends on the pressures, temperatures and cell core technology used.

The separators incorporating one or more orifices as described above can be connected directly to a module for diluting in air or to a catalytic incinerator. This connection can also be made via a valve which will provide for leaktight closing of the draining in some operating phases. Finally, a phase separator like those described above can be incorporated in the head or in one of the end plates of the fuel cell to which it is connected, in order to gain further in compactness of the FC system.

The separators incorporating one or more orifices as described above can be directly connected to a module for diluting in air or to a catalytic incinerator. This connection can also be made via a valve which will provide for leaktight closing of the draining in some operating phases.

The management of the draining with the various phase separators described above is more or less flexible according to the cases described:

with a single orifice, the draining flow rate depends only on the hydrogen pressure in the phase separator. One means for adjusting this flow rate can be to vary the pressure in the hydrogen line: the latter will vary according to the power supplied by the cell; in this case, a low pressure will be used for operation at low power as the performance of the system is improved by a decrease in the draining flow rate; if necessary, it will also be possible, for low powers, to return to a mode of operation by periodic opening of a valve downstream of the orifice;

with several orifices, the variations in flow rate are simple to produce using a selector such as those described above. The selector can be set in motion by electrical and/or pneumatic means; as in the preceding case, it is possible to combine therewith a variation in the hydrogen pressure as a function of the level of power supplied by the cell; a mode of operation by periodic opening of a valve downstream of the orifices can also be envisaged here.

The periodic opening of a valve situated downstream of the orifices makes it possible to finely regulate the concentration of nitrogen in the hydrogen line. It is distinguished from the draining systems employed in the prior art owing to the fact that the rate of decrease in the concentration during the phase of opening the valve is much lower, which makes the regulation more exact.

An example from the prior art of regulating the concentration of nitrogen in the hydrogen line by periodic draining is represented in FIG. 5. The concentration of nitrogen in the hydrogen line falls suddenly (from 60% to zero) on opening the drain valve, whereas it increases slowly when the valve is closed. It is thus possible to take advantage of these slow kinetics by combining a drain valve with a calibrated orifice device as described above. In order to limit the loss of hydrogen via this orifice in some operating phases, the periodic closing of the drain valve makes it possible to greatly reduce the exiting flow rate (for example by a factor of 2 for an opening time/closing time ratio of 1), while regulating the concentration of nitrogen within a range compatible with effective operation of the fuel cell. A system is then present which is virtually equivalent to a smaller orifice.

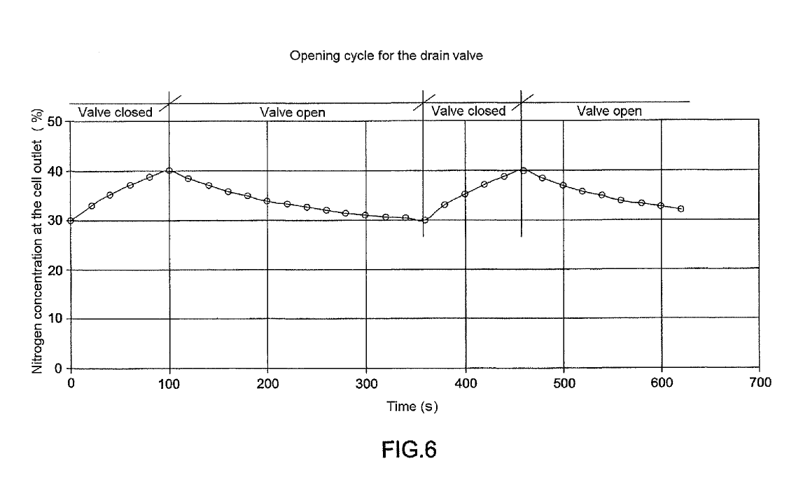

An example of this mode of operation of the hydrogen line by alternate opening and closing of a draining line incorporating a calibrated orifice in one embodiment of the invention is represented in FIG. 6. In this case, the durations of opening and of closing of the orifice are closer and the range of variation in the nitrogen concentration remains narrow (in this instance between 30 and 40%).

The examples described above are given by way of illustration of embodiments of the invention. They do not in any way limit the scope of the invention, which is defined by the following claims.

What is claimed is:

1. A circuit for recycling fuel or oxidant coupled to a fuel cell comprising at least one drain of the products of the reactions from the cells and one separator of the phases of said products, said drain forming an outlet of the separator and comprising several calibrated outlet orifices each controlled by an electromechanical valve, the opening and the closing of which are controlled in order to choose the group of the outlet orifices which are active at a given instant, wherein said calibrated orifices are positioned in a housing, the face of which internal to the separator has at least one hole with dimensions fit to the calibers of the outlet orifices and for moving to hide a portion of the calibrated orifices under command of one of an electrical and a pneumatic controller.

2. The recycling circuit of claim 1, wherein the housing has substantially the shape of a cylinder and in that the movement of the internal face of said cavity is a rotary movement.

3. The recycling circuit of claim 2, wherein the face internal to the separator has a single hole, the position of which corresponds either to the activation of just one of the outlet orifices or to the complete passivation of the drain.

4. The recycling circuit of claim 2, wherein the face internal to separator has a single hole, the position of which corresponds either to the activation of at least two of the related outlet orifices or to the complete passivation of the drain.

5. The recycling circuit of claim 1, wherein a module is provided at the outlet of the drain in order to carry out a treatment of the effluents chosen from the group consisting of dilution and catalytic incineration.

6. A process for the production of an electric current in a fuel cell comprising an assembly of individual cells having an anode and a cathode, said assembly being supplied with fuel and with oxidant, one or other being composed of a circuit for recycling the gas mixture, said process comprising a step of draining the products of the reactions from the cells, the flow rate for effluents of which, at the outlet of the draining step, is controlled by alternate opening/closing of several calibrated orifices, wherein said calibrated orifices are positioned in a housing, the face of which internal to of a separator the phases has at least one hole with dimensions fit to the calibers of the outlet orifices, said process further comprising moving said internal face of said housing by one of an electrical and a pneumatic command in order to hide a portion of the calibrated orifices.

7. The process for producing electric current of claim 6, wherein the recycling circuit comprises:
at least one drain of the products of the reactions from the cells and one separator of the phases of said products, said drain fanning an outlet of the separator and comprising several calibrated outlet orifices each controlled by an electromechanical valve, the opening and the closing of which are controlled in order to choose the group of the outlet orifices which are active at a given instant, wherein said calibrated orifices are positioned in a housing, the face of which internal to the separator has at least one hole with dimensions fit to the calibers of the outlet orifices and for moving to hide a portion of the calibrated orifices under command of one of an electrical and a pneumatic controller,
wherein the housing has substantially the shape of a cylinder and in that the movement of the internal face of said cavity is a rotary movement.

8. The process for producing electric current of claim 7, wherein the mode of control of the flow rate for effluents at the outlet of the draining stage is combined with a variation in the pressure in the hydrogen feed line.

9. A circuit for recycling fuel or oxidant coupled to a fuel cell comprising means for draining the products of the reactions from the cells and means for separating the phases of said products, said draining means constituting an outlet of the means for separating the phases and comprising several calibrated outlet orifices each controlled by an electromechanical valve, the opening and the closing of which are controlled in order to choose the group of the outlet orifices which are active at a given instant, wherein said calibrated orifices are positioned in a housing, the face of which internal to the means for separating the phases has at least one hole with dimensions suited to the calibers of the outlet orifices and is capable of moving in order to hide a portion of the calibrated orifices under the control of means chosen from the group of the electrical and pneumatic means.
